(19) United States
(12) Patent Application Publication
(10) Pub. No.: US 2024/0054815 A1
(43) Pub. Date: Feb. 15, 2024

(54) INFORMATION PROCESSING APPARATUS, INFORMATION PROCESSING METHOD, COMPUTER-READABLE MEDIUM, AND INFORMATION PROCESSING SYSTEM

(71) Applicant: NEC Corporation, Minato-ku, Tokyo (JP)

(72) Inventors: Ryoutarou Saka, Tokyo (JP); Natsuki Yui, Tokyo (JP)

(73) Assignee: NEC Corporation, Minato-ku, Tokyo (JP)

(21) Appl. No.: 18/270,990

(22) PCT Filed: Feb. 10, 2022
(86) PCT No.: PCT/JP2022/005425

§ 371 Date: Jul. 5, 2023

(30) Foreign Application Priority Data
Mar. 31, 2021 (JP) 2021-059305

(51) Int. Cl. G06V 40/20; G06V 20/52; G08B 21/04

(52) U.S. Cl. CPC G06V 40/20; G06V 20/52; G08B 21/0423

(57) ABSTRACT

An information processing apparatus (10) includes: an acquisition unit (11) that acquires information detected based on an image captured by an imaging apparatus (20); a determination unit (12) that performs a first determination process of determining to output a warning when a type of an object detected at time of start and end of a first period is a person, and a second determination process of determining to output a warning when behavior of the person detected based on the image continues for a second period or longer; and an output unit (13) that outputs the warning based on a result determined by the determination unit.

### TECHNICAL FIELD

The present disclosure relates to an information processing apparatus, an information processing method, a program, and an information processing system.

### BACKGROUND ART

A system has been known that analyzes behavior of a person (user) based on an image captured by a camera. Patent Literature 1 related to such a system discloses that an alarm is output in order to prevent a decrease in work efficiency due to continuation of the same work when the same pose continues for a predetermined period of time based on an image of a user captured by a camera. Patent Literature 1 discloses that an alarm is output when it is determined that a user continues a keyboard operating pose for one hour or longer, or when the user is on the phone for one hour or longer.

### CITATION LIST

### Patent Literature

Patent Literature 1: Japanese Unexamined Patent Application Publication No. 2007-048232

### SUMMARY OF INVENTION

### Technical Problem

However, the technique disclosed in Patent Literature 1 has a problem that a warning may not be appropriately output when behavior of a pedestrian or the like is monitored, for example.

An object of the present disclosure is to provide an information processing apparatus, an information processing method, a program, and an information processing system that can appropriately output a warning based on an image in view of the above-described problem.

### Solution to Problem

A first aspect according to the present disclosure provides an information processing apparatus including: an acquisition unit that acquires information detected based on an image captured by an imaging apparatus; a determination unit that performs a first determination process of determining to output a warning when a type of an object detected at time of start and end of a first period is a person, and a second determination process of determining to output a warning when behavior of the person detected based on the image continues for a second period or longer; and an output unit that outputs the warning based on a result determined by the determination unit.

A second aspect according to the present disclosure provides an information processing method including: acquiring information detected based on an image captured by an imaging apparatus; determining to output a warning when a type of an object detected at time of start and end of a first period is a person, and determining to output a warning when behavior of the person detected based on the image continues for a second period or longer; and outputting the warning based on the determination result.

A third aspect according to the present disclosure provides a program that causes an information processing apparatus to execute: a process of acquiring information detected based on an image captured by an imaging apparatus; a first determination process of determining to output a warning when a type of an object detected at time of start and end of a first period is a person, and a second determination process of determining to output a warning when behavior of the person detected based on the image continues for a second period or longer; and a process of outputting the warning based on a determination result.

A fourth aspect according to the present disclosure provides an information processing system including an imaging device that captures an image and an information processing apparatus. In the information processing system, the information processing apparatus includes: an acquisition unit that acquires information detected based on an image captured by the imaging apparatus; a determination unit that performs a first determination process of determining to output a warning when a type of an object detected at time of start and end of a first period is a person, and a second determination process of determining to output a warning when behavior of the person detected based on the image continues for a second period or longer; and an output unit that outputs the warning based on a result determined by the determination unit.

### Advantageous Effect of Invention

According to one aspect, it is possible to appropriately output a warning based on an image.

### BRIEF DESCRIPTION OF DRAWINGS

FIG. 1 is a diagram showing an example of a configuration of an information processing apparatus according to an example embodiment;

FIG. 2 is a diagram showing a configuration example of an information processing system according to an example embodiment;

FIG. 3 is a diagram showing a hardware configuration example of an information processing apparatus according to the example embodiment;

FIG. 4 is a flowchart showing an example of processing of the information processing apparatus according to the example embodiment;

FIG. 5 is a diagram for explaining an example of a first determination process according to the example embodiment;

FIG. 6 is a diagram for explaining an example of a second determination process according to the example embodiment;

FIG. 7 is a diagram showing an example of behavior of persons detected based on an image captured by an imaging apparatus according to the example embodiment;

FIG. 8 is a diagram for explaining an example of a determination process of the information processing apparatus according to the example embodiment; and

FIG. 9 is a diagram showing an example of a configuration of an information processing apparatus according to an example embodiment.

### EXAMPLE EMBODIMENTS

Principle of the present disclosure will be described with reference to some example embodiments. It is to be understood that these example embodiments are described only for the purpose of illustration and help those skilled in the art to understand and implement the present disclosure, without suggesting any limitations as to the scope of the present disclosure. The disclosure described herein can be implemented in various manners other than the following description.

In the following description and claims, unless defined otherwise, all technical and scientific terms used herein have the same meaning as commonly understood by one of ordinary skilled in the art to which the present disclosure belongs.

Example embodiments of the present invention will be described below with reference to the drawings.

### First Example Embodiment

### <Configuration>

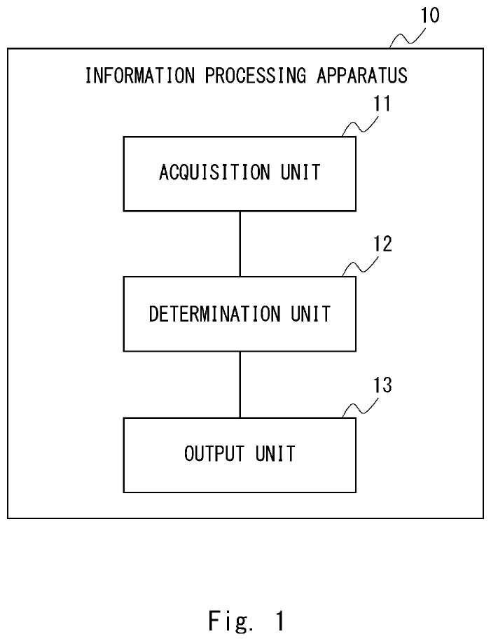

A configuration of an information processing apparatus 10 according to an example embodiment will be described with reference to FIG. 1. FIG. 1 is a diagram showing an example of the configuration of the information processing apparatus 10 according to the example embodiment. The information processing apparatus 10 includes an acquisition unit 11, a determination unit 12, and an output unit 13. These components may be implemented by cooperation between one or more programs installed in the information processing apparatus 10 and hardware such as a processor 101 and a memory 102 of the information processing apparatus 10.

The acquisition unit 11 acquires various kinds of information from a storage unit inside the information processing apparatus 10 or an external apparatus. The acquisition unit 11 acquires information detected based on an image captured by an imaging apparatus 20, for example. In this case, the acquisition unit 11 may detect (acquire) information based on the image captured by the imaging apparatus 20. Further, the acquisition unit 11 may acquire information about behavior of the person detected by another module inside the information processing apparatus 10 or by an external apparatus.

The determination unit 12 performs various determinations on recording of the image captured by the imaging apparatus 20, based on the information acquired by the acquisition unit 11. The “image” of the present disclosure includes at least one of a moving image and a still image. The determination unit 12 may determine to output a warning when a type of an object detected at the time of start and end of a first period is a person, for example. In addition, the determination unit 12 may determine to output a warning when behavior of the person detected based on the image continues for a second period or longer, for example. The output unit 13 outputs (broadcasts) a warning (alert, warning notification, or alarm) based on a result determined by the determination unit 12.

### Second Example Embodiment

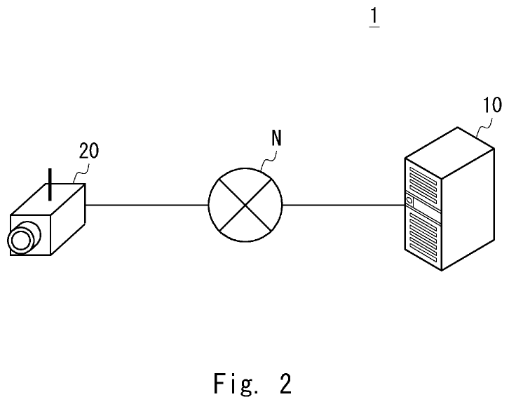

A configuration of an information processing system 1 according to an example embodiment will be described below with reference to FIG. 2.

### <Configuration of System>

FIG. 2 is a diagram showing a configuration example of the information processing system 1 according to the example embodiment. In FIG. 2, the information processing system 1 includes an information processing apparatus 10 and an imaging apparatus 20. In the example of FIG. 2, the information processing apparatus 10 and the imaging apparatus 20 are connected so as to be communicable with each other via a network N. The number of the information processing apparatuses 10 and the number of the imaging apparatuses 20 are not limited to the example in FIG. 2.

Examples of the network N include the Internet, a mobile communication system, a wireless LAN (Local Area Network), a LAN, a bus, and the like. Examples of the mobile communication system include a fifth generation mobile communication system (5G), a fourth generation mobile communication system (4G), a third generation mobile communication system (3G), and the like.

The information processing apparatus 10 is a device such as a server, a cloud, a personal computer, a network video recorder, or a smartphone. The information processing apparatus 10 outputs a warning based on the image captured by the imaging apparatus 20.

The imaging apparatus 20 is a device such as a network camera, a camera, or a smartphone. The imaging apparatus 20 captures an image using a camera, and outputs (transmits) the captured image to the information processing apparatus 10.

### <Hardware Configuration>

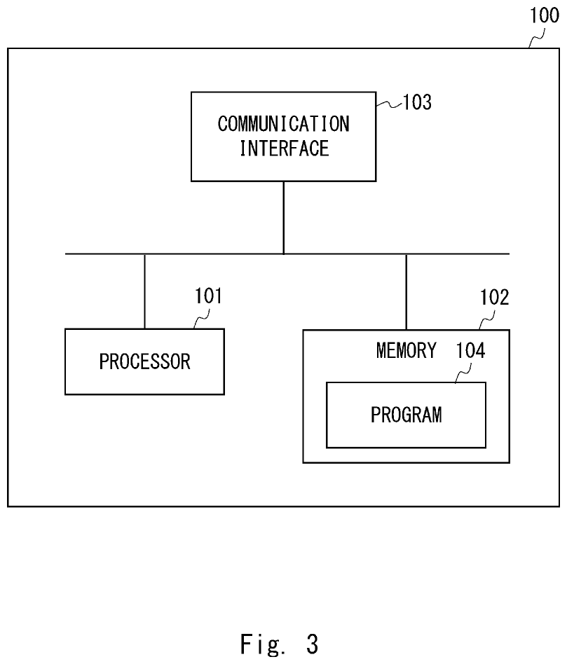

FIG. 3 is a diagram showing a hardware configuration example of the information processing apparatus 10 according to the example embodiment. In the example of FIG. 3, the information processing apparatus 10 (computer 100) includes a processor 101, a memory 102, and a communication interface 103. These components may be connected via a bus, for example. The memory 102 stores at least a portion of a program 104. The communication interface 103 includes interfaces necessary for communication with other network elements.

When the program 104 is executed by cooperation of the processor 101 and the memory 102, the computer 100 performs at least a part of the processes of the example embodiment of the present disclosure. The memory 102 may be of any type suitable for a local technical network. The memory 102 may be, as a non-limiting example, a non-transitory computer readable storage medium. Further, the memory 102 may be implemented using any suitable data storage technology, such as semiconductor-based memory devices, magnetic memory devices and systems, optical memory devices and systems, fixed memory and removable memory, and the like. Although only one memory 102 is shown in the computer 100, there may be several physically different memory modules in the computer 100. The processor 101 may be of any type. The processor 101 may include one or more of general purpose computers, special purpose computers, microprocessors, digital signal processors (DSPs), and processors based on multicore processor architecture, as non-limiting examples. The computer 100 may have multiple processors, such as application specific integrated circuit chips that are temporally dependent on a clock which synchronizes the main processor.

Example embodiments of the present disclosure may be implemented in hardware or dedicated circuits, software, logic, or any combination thereof. Some aspects may be implemented in hardware, while other aspects may be implemented in firmware or software which may be executed by a controller, microprocessor, or other computing device.

The present disclosure also provides at least one computer program product tangibly stored on a non-transitory computer readable storage medium. The computer program product includes computer-executable instructions, such as those included in program modules, being executed in a device on a target real or virtual processor, to perform a process or a method of the present disclosure. The program modules include routines, programs, libraries, objects, classes, components, data structures, or the like that execute particular tasks or implement particular abstract data types. The functionality of the program modules may be combined or split between program modules as desired in various example embodiments. Machine-executable instructions for program modules may be executed within a local or a distributed device. In the distributed device, program modules may be located in both local and remote storage media.

Program code for executing a method of the present disclosure may be written in any combination of one or more programming languages. These program codes may be provided to a processor or a controller of a general purpose computer, a special purpose computer, or another programmable data processing apparatus. When the program code is executed by the processor or the controller, functions/operations in a flowchart and/or block diagrams to be implemented are executed. The program code may be executed entirely on a machine, partly on the machine, as a stand-alone software package, partly on the machine, and partly on a remote machine, or entirely on the remote machine or server.

The program may be stored and supplied to a computer using various types of non-transitory computer readable media. The non-transitory computer readable media include various types of tangible storage media. Examples of the non-transitory computer readable media include a magnetic recording medium, a magneto-optic recording medium, an optical disk medium, a semiconductor memory, and the like. Examples of the magnetic recording medium include a flexible disk, a magnetic tape, a hard disk drive, and the like. Examples of the magneto-optic recording medium include a magneto-optic disk and the like. Exampled of the optical disk medium include a Blu-ray disc, a CD (Compact Disc)-ROM (Read Only Memory), a CD-R (Recordable), a CD-RW (ReWritable), and the like. Examples of the semiconductor memory include a solid state drive, a mask ROM, a PROM (Programmable ROM), an EPROM (Erasable PROM), a flash ROM, a RAM (Random Access Memory), and the like. These programs may be supplied to computers using various types of transitory computer readable media. Examples of the transitory computer readable media include an electrical signal, an optical signal, and an electromagnetic wave. The transitory computer readable media can supply programs to a computer through a wired communication line, for example, electric wires and optical fibers, or a wireless communication line.

### <Processing>

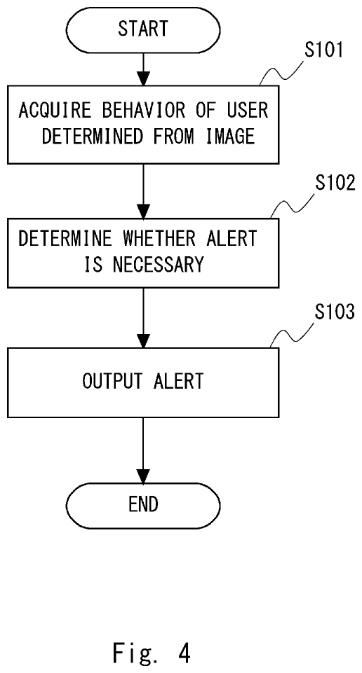

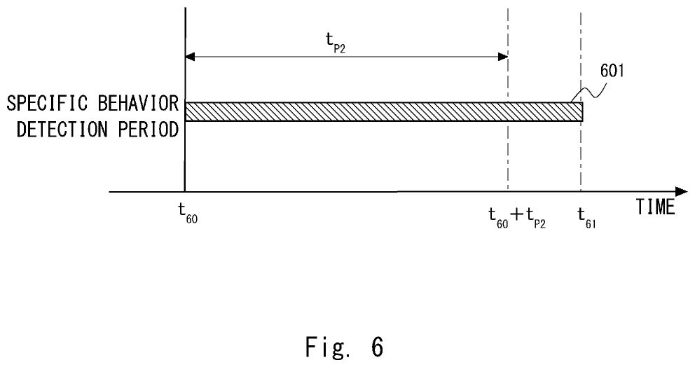

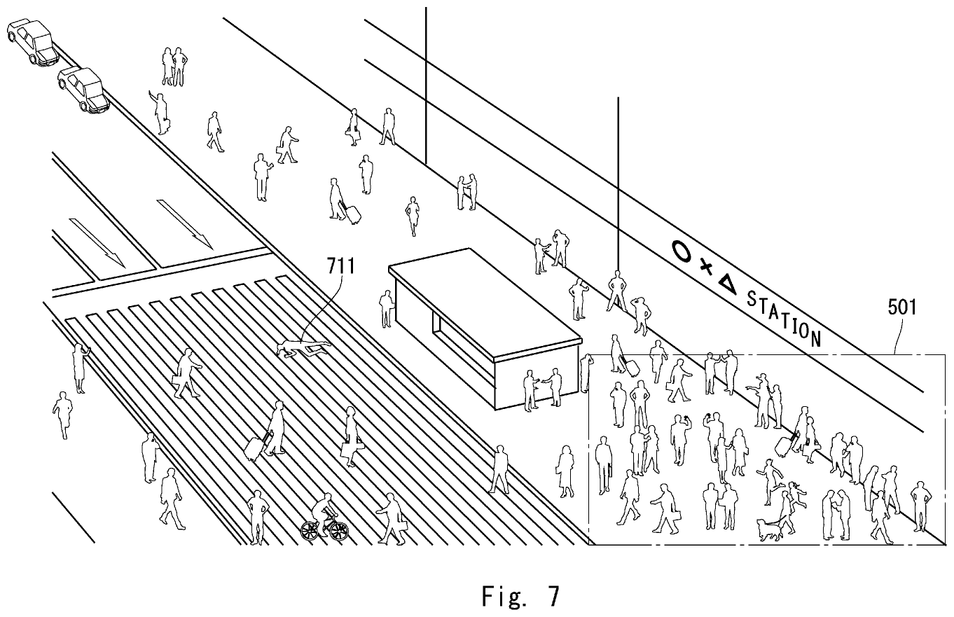

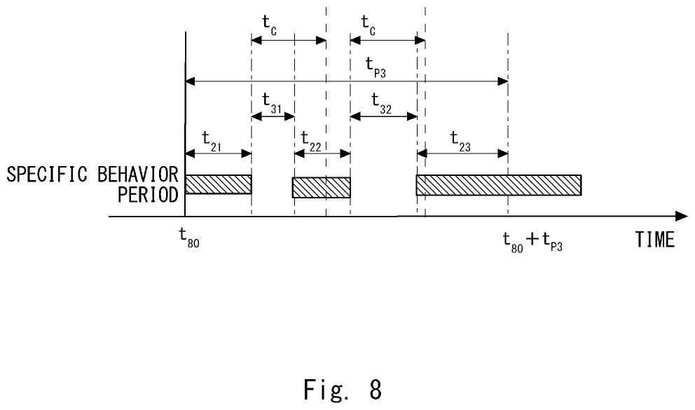

An example of processing of the information processing apparatus 10 according to the example embodiment will be described below with reference to FIGS. 4 to 8. FIG. 4 is a flowchart showing an example of processing of the information processing apparatus 10 according to the example embodiment. FIG. is a diagram for explaining an example of a first determination process according to the example embodiment. FIG. 6 is a diagram for explaining an example of a second determination process according to the example embodiment. FIG. 7 is a diagram showing an example of behavior of persons detected based on an image captured by an imaging apparatus 20 according to the example embodiment. FIG. 8 is a diagram for explaining an example of a determination process of the information processing apparatus 10 according to the example embodiment.

The information processing apparatus 10 tracks, based on positions, moving directions, moving speeds, features (for example, surface colors and heights) and the like of persons in frames captured by the imaging apparatus 20 at points of time, positions and behavior of persons. Then, the information processing apparatus 10 executes the following process for each of the plurality of persons representing in the image captured by the imaging apparatus 20. Therefore, hereinafter, any one of the plurality of persons representing in the image captured by the imaging apparatus 20 is also referred to as a “person to be determined” as appropriate.

In step S1, the acquisition unit 11 of the information processing apparatus acquires information indicating behavior of a person to be determined, which is detected based on the image captured by the imaging apparatus 20. A process of detecting the behavior of the person to be determined may be performed by any of the information processing apparatus 10, the imaging apparatus 20, and the external apparatus, for example. When the information processing apparatus 10 detects the behavior of the person to be determined, the information processing apparatus 10 may detect (estimate or infer) the behavior by AI (Artificial Intelligence) using deep learning. In this case, the information processing apparatus 10 may estimate a skeleton (a connection state of joint points) of the person to be determined based on the image captured by the imaging apparatus 20, for example. Then, the information processing apparatus 10 may determine that the person to be determined adopts a specific pose when a similarity (for example, cosine similarity) between the estimated skeleton and a skeleton in a specific pose registered in advance is equal to or greater than a threshold. In the example of FIG. 7, it is detected in an image 700 captured by the imaging apparatus 20 that a person 711 is fallen as behavior of the person 711.

Subsequently, the determination unit 12 of the information processing apparatus 10 determines whether a warning is necessary (step S2).

### (First Determination Process)

The determination unit 12 may perform the first determination process of determining to output a warning when a type of object detected at the time of start and end of a first period (for example, for 10 seconds) is a person. The predetermined region may be, for example, a region where an off-limit (no trespassing) place is shown in the image captured by the imaging apparatus 20. The predetermined region may be set in the information processing apparatus 10 in advance by an operator or the like. Thus, for example, when a person enters an off-limit area, a warning can be output as appropriate even when there is a period of time in which the person cannot be detected due to a vehicle which is running in front of the person as seen from the imaging apparatus 20.

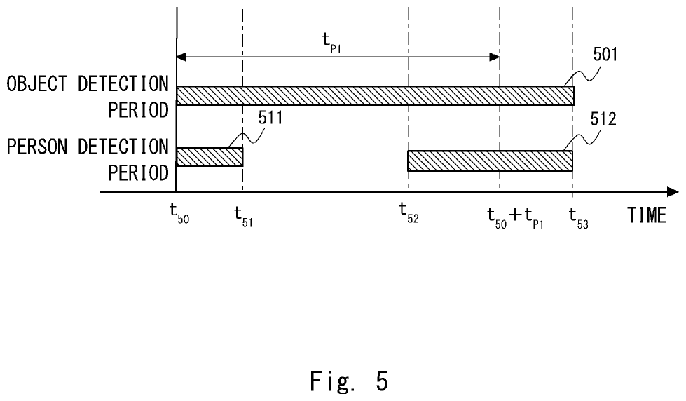

In the example of FIG. 5, it is shown that a person is continuously detected within a predetermined region during a period 511 from a point of time t₅₀ to a point of time t₅₁ and a period 512 from a point of time t₅₂ to a point of time t₅₃. In the example of FIG. 5, therefore, a person is detected within the predetermined region at the time of start of a first period tₚ₁ (for example, the point of time t₅₀), and is also detected within the predetermined region at the time of end thereof (for example, a point of time t₅₀+tₚ₁). For this reason, the determination unit 12 determines to output a warning in the first determination process.

In addition, the determination unit 12 may determine to output a warning in the first determination process when an object is continuously detected within the predetermined region of the image for the first period (for example, for 10 seconds) and the type of the object detected at the time of start and end of the first period is a person. Thus, for example, when a person enters an off-limit area, a warning can be output as appropriate even when there is a period of time in which only a vehicle is detected instead of the person at the position of the person. In the example of FIG. 5, since the period 501, during which the object is detected, continues from the point of time t₅₀ to a point of time t₅₃ (>t₅₀+tₚ₁), it is shown that the object is continuously detected for the first period tₚ₁ or longer within the predetermined region.

### (Second Determination Process)

Further, the determination unit 12 may perform a second determination process of determining to output a warning when the specific behavior of the person detected based on the image continues for a second period (for example, for 10 seconds) or longer. The determination unit 12 may perform the second determination process on a region in the image set in the information processing apparatus 10 in advance by the operator, for example. Thus, for example, when a person falls over and sits down for a certain period of time or longer, a warning can be appropriately output. In the example of FIG. 6, since a period 601, during which the specific behavior of the person is detected, continues from a point of time t₆₀ to a point of time t₆₂ (>t₆₀+t_{P2}), it is shown that the specific behavior continues for the second period t_{P2} or longer. Therefore, the determination unit 12 determines to output a warning in the second determination process.

The determination unit 12 may determine, based on the behavior of the person detected based on the image, one or more determination processes of the behavior of the person from a plurality of determination processes including the first determination process and the second determination process. In this case, the operator or the like may designate, in the information processing apparatus 10, one or more determination processes of determining whether a warning is necessary for each type of behavior.

Then, the determination unit 12 may execute the first determination process when the behavior of the person detected based on the image is first behavior (for example, entering the off-limit area). In addition, the determination unit 12 may execute the second determination process when the behavior of the person detected based on the image is second behavior (for example, falling over, sitting down, and crouching). Thus, it is possible to appropriately determine whether a warning is necessary according to the behavior of the person.

### (Third Determination Process)

In addition, the determination unit 12 may determine whether a total length of time, during which the person to be determined is performing specific behavior in a specific period (hereinafter, also referred to as a “behavior determination period” as appropriate. For example, for 20 seconds), is equal to or greater than a first threshold (hereinafter, also referred to as a “behavior determination threshold” as appropriate. For example, 10 seconds). Then, the determination unit 12 may determine to output a warning when the total length of time is equal to or greater than the behavior determination threshold. Thus, it is possible to appropriately output a warning based on the image, for example.

Further, the determination unit 12 may determine not to output a warning when a period, during which the specific behavior of the person to be determined is not continuously detected in the behavior determination period, is equal to or greater than a second threshold (hereinafter, also referred to as a “behavior continuation threshold” as appropriate. For example, 3 seconds). Thus, it is possible to appropriately output a warning based on the image, for example.

In the example of FIG. 8, it is shown that a total length of time (specific behavior period), during which the person to be determined is performing a specific behavior in the behavior determination period t_{P3}, is t₂₁+t₂₂+t₂₃. Further, each of lengths of a period t₃₁ and a period t₃₂, during which the person to be determined is not performing the specific behavior in the behavior determination period t_{P3}, is less than a behavior continuation threshold t_{C}. In this case, the determination unit 12 may determine to output a warning when the total length of time (t₂₁+t₂₂+t₂₃) is equal to or greater than the behavior determination threshold, and may determine not to output a warning when the total length of time is less than the behavior determination threshold.

### (Example of Determining at Least One of Length of Behavior Determination Period, Behavior Determination Threshold, and Behavior Continuation Threshold)

The determination unit 12 may determine, based on predetermined conditions, at least one of the length of the behavior determination period, the behavior determination threshold, and the behavior continuation threshold. Thus, it is possible to more appropriately determine whether a warning is necessary, for example. This is because of reducing the possibility that the warning is not output even when, for example, a total period during which the behavior of the person to be determined cannot be detected becomes relatively long due to at least one of the lengthening of the behavior determination period and the reduction of the behavior determination threshold. In addition, this is because of reducing the possibility that the warning is not output even when, for example, a total period during which the behavior of the person to be determined cannot be detected becomes relatively long due to the increasing of the behavior continuation threshold. Examples of the predetermined conditions will be described below. The determination unit 12 may determine at least one of the length of the behavior determination period, the behavior determination threshold, and the behavior continuation threshold by combining a plurality of conditions below.

### ((Example of Determining Based on Surrounding Circumstances of Person))

The determination unit 12 may determine at least one of the length of the behavior determination period, the behavior determination threshold, and the behavior continuation threshold, based on surrounding circumstances of the person to be determined, the circumstances being determined based on an image captured by the imaging apparatus 20. In this case, the determination unit 12 may determine at least one of the length of the behavior determination period, the behavior determination threshold, and the behavior continuation threshold, based on the degree of congestion around the person to be determined, for example. In this case, the determination unit 12 may determine that the greater the number of persons and moving objects (for example, vehicles) existing in the surrounding (for example, an image region of a predetermined range including a region in which the person is captured) of the person to be determined, the higher the degree of congestion around the person to be determined, for example. Then, when the degree of congestion is not equal to or greater than a predetermined degree of congestion threshold, the determination unit 12 may determine that the length of the behavior determination period is a first period length, the behavior determination threshold is a first behavior determination threshold, and the behavior continuation threshold is a first behavior continuation threshold.

In addition, when the degree of congestion is equal to or greater than the predetermined degree of congestion threshold, the determination unit 12 may determine that the length of the behavior determination period is a second period length longer than the first period length, the behavior determination threshold is a second behavior determination threshold smaller than the first behavior determination threshold, and the behavior continuation threshold is a second behavior continuation threshold larger than the first behavior continuation threshold. For example, even when the surrounding of a certain person is congested like a region 701 in FIG. 7 and thus the person is frequently hidden behind other persons or moving objects moving toward a front side (front side as viewed from the imaging apparatus 20), it is possible to more appropriately determine whether a warning is necessary.

((Example of Determining Based on at Least One of Time when Image is Captured and Place where Image is Captured))

In addition, the determination unit 12 may determine at least one of the length of the behavior determination period, the behavior determination threshold, and the behavior continuation threshold, based on at least one of a time when the image is captured by the imaging apparatus 20 and a place where the image is captured by the imaging apparatus 20. In this case, when the time when the image is captured by the imaging apparatus 20 is not within a predetermined period of time, the determination unit 12 may determine that the length of the behavior determination period is a third period length, the behavior determination threshold is a third behavior determination threshold, and the behavior continuation threshold is a third behavior continuation threshold. The predetermined period of time may be set in the information processing apparatus in advance.

Further, when the time when the image is captured by the imaging apparatus 20 is within the predetermined period of time, the determination unit 12 may determine that the length of the behavior determination period is a fourth period length longer than the third period length, the behavior determination threshold is a fourth behavior continuation threshold smaller than the third behavior continuation threshold, and the behavior continuation threshold is a fourth behavior continuation threshold larger than the third behavior continuation threshold. Thus, for example, even in a period of time in the morning in busy due to commuting and in a period of time in the evening in busy due to returning home, it is possible to more appropriately determine whether a warning is necessary.

Further, the determination unit 12 may determine initial values of the behavior determination period and the behavior determination threshold according to the imaging apparatus 20. Each of the initial values may be set in the information processing apparatus 10 in advance for each of one or more imaging apparatuses 20. Thus, when the behavior of the person is detected based on the image captured by the imaging apparatus 20 that captures a station square with a relatively high degree of congestion, it is possible to reduce the possibility that the warning is not output even when a total period during which the behavior of the person to be determined cannot be detected becomes relatively long.

### ((Example of Determining Based on Type of Object in Front of Person))

In addition, the determination unit 12 may determine at least one of the length of the behavior determination period, the behavior determination threshold, and the behavior continuation threshold, based on a type of an object in front of the person to be determined (front side as viewed from the imaging apparatus 20) in the image captured by the imaging apparatus 20. In this case, when the type of the object in front is a person and a vehicle, the determination unit 12 may determine that the length of the behavior determination period is a fifth period length, the behavior determination threshold is a fifth behavior continuation threshold, and the behavior continuation threshold is a fifth behavior continuation threshold.

Further, when the type of the object in front is a bus and a trolley, the determination unit 12 may determine that the length of the behavior determination period is a sixth period length longer than the fifth period length, the behavior determination threshold is a sixth behavior continuation threshold smaller than the fifth behavior continuation threshold, and the behavior continuation threshold is a sixth behavior continuation threshold larger than the fifth behavior continuation threshold. Thus, for example, even when the person to be determined is not captured for a long time due to the bus or the road trolley, it is possible to more appropriately determine whether a warning is necessary.

### ((Example of Determining Based on Type of Behavior Performed by Person))

In addition, the determination unit 12 may determine at least one of the length of the behavior determination period, the behavior determination threshold, and the behavior continuation threshold, based on a type of behavior performed by the person to be determined, for example. In this case, when the type of the behavior performed by the person to be determined is sneezing, coughing, or non-wearing of a mask, the determination unit 12 may determine that the length of the behavior determination period is a seventh period length, the behavior determination threshold is a seventh behavior continuation threshold, and the behavior continuation threshold is a seventh behavior continuation threshold.

Further, when the type of the behavior performed by the person to be determined is falling over, sitting down, and crouching, the determination unit 12 may determine that the length of the behavior determination period is an eighth period length longer than the seventh period length, the behavior determination threshold is an eighth behavior continuation threshold larger than the seventh threshold, and the behavior continuation threshold is the fourth behavior continuation threshold smaller than the third behavior continuation threshold. Thus, for example, according to the behavior such as sneezing in which a person may move out of the photographable range of the imaging apparatus 20 in a relatively short time and the behavior such as falling over in which the person is likely to remain within the photographable range for a relatively long time, it is possible to more appropriately determine whether a warning is necessary.

### ((Example of Determining Based on Attributes of Person))

In addition, the determination unit 12 may determine at least one of the length of the behavior determination period, the behavior determination threshold, and the behavior continuation threshold, based on attributes of a person to be determined, which are determined based on the image captured by the imaging apparatus 20, for example. A process of detecting attributes of the person may be performed by any of the information processing apparatus 10, the imaging apparatus 20, and the external apparatus, for example. When the information processing apparatus 10 detects the attributes of the person, the information processing apparatus 10 may detect (estimate or infer) the attributes of the person (for example, age, gender, and height) by AI using deep learning, for example.

In this case, when the attribute of the person to be determined is not a predetermined attribute (for example, an aged person), the determination unit 12 may determine that the length of the behavior determination period is a ninth period length, the behavior determination threshold is a ninth behavior continuation threshold, and the behavior continuation threshold is a ninth behavior continuation threshold.

Further, when the attribute of the person to be determined is a predetermined attribute, the determination unit 12 may determine that the length of the behavior determination period is a tenth period length longer than the ninth period length, the behavior determination threshold is a tenth behavior continuation threshold smaller than the ninth behavior continuation threshold, and the behavior continuation threshold is a tenth behavior continuation threshold larger than the ninth behavior continuation threshold. Thus, for example, when the attribute of the person to be determined is an aged person, a warning can be output if the person is fallen over for a relatively short time during a relatively short behavior determination period. In addition, a warning can be output even when the person is fallen over intermittently.

Subsequently, the output unit 13 of the information processing apparatus 10 outputs a warning based on the result determined by the determination unit 12 (step S3). Here, the output unit 13 may display a warning on a display screen of the information processing apparatus 10, for example. Further, the output unit 13 may cause a speaker of the information processing apparatus 10 to output a warning sound, for example. The output unit 13 may also transmit a warning message to a terminal such as a smartphone possessed by a watchman (security guard) or a server of a monitoring center.

### Third Example Embodiment

### <Configuration>

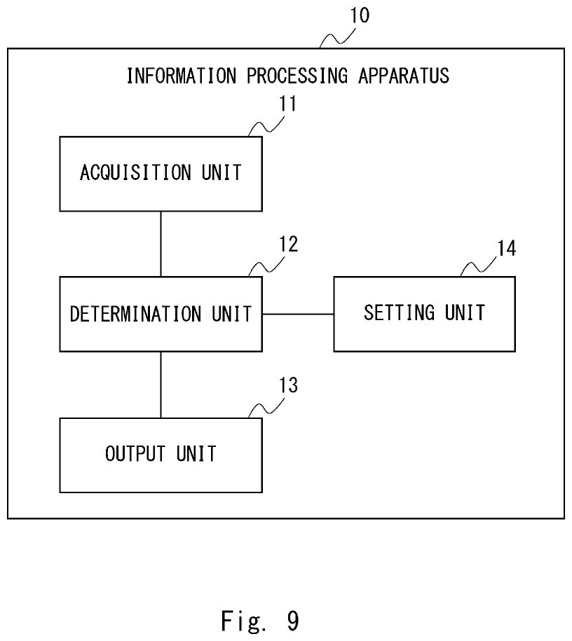

A configuration of an information processing apparatus 10 according to an example embodiment will be described with reference to FIG. 9. FIG. 9 is a diagram showing the configuration of the information processing apparatus 10 according to the example embodiment. The example of FIG. 9 is different mainly from the example of FIG. 1 in that the information processing apparatus 10 includes a setting unit 14. The setting unit 14 may be implemented by cooperation between one or more programs installed in the information processing apparatus 10 and hardware such as a processor 101 and a memory 102 of the information processing apparatus 10.

The setting unit 14 sets various kinds of information used for processing of the determination unit 12 described above. The setting unit 14 may set information designated by an operator (user or administrator) of the information processing apparatus 10, for example. In addition, the setting unit 14 may set information designated by a setting file or the like set during shipment of the information processing apparatus 10 from a factory or the like, for example.

The setting unit 14 may set one or more determination processes of determining whether a warning is necessary for each region in the image captured by the imaging apparatus 20, from a plurality of determination processes including a first determination process, a second determination process, and a third determination process. Then, the determination unit 12 may perform, based on the information set by the setting unit 14, a determination process according to the region in the image in which the person to be determined is captured. Thus, for example, the first determination process can be set for a region in which the off-limit area is captured. Further, for example, the second determination process and the third determination process can be set for a region in which a gateway of a facility such as a store is captured.

In addition, the setting unit 14 may set one or more determination processes of determining whether a warning is necessary for each type of behavior of a person, from a plurality of determination processes including a first determination process, a second determination process, and a third determination process. Then, the determination unit 12 may perform, based on the information set by the setting unit 14, a determination process according to the type of behavior of the person to be determined. Thus, for example, the second determination process and the third determination process can be set for the types of behavior such as falling over, sitting down, and crouching.

The setting unit 14 may set one or more determination processes of determining whether a warning is necessary for a combination of each region in the image captured by the imaging apparatus 20 and each type of behavior of the person, from a plurality of determination processes including a first determination process, a second determination process, and a third determination process. Then, the determination unit 12 may perform, based on the information set by the setting unit 14, a determination process according to the region in the image in which the person to be determined is captured and the type of behavior of the person to be determined. Thus, for example, the first determination process can be set for the behavior such as entering the off-limits area.

### <Modification>

The information processing apparatus 10 may be an apparatus contained in one housing, but the information processing apparatus 10 of the present disclosure is not limited thereto. Each of the components of the information processing apparatus 10 may be implemented by cloud computing configured by one or more computers, for example. Further, the information processing apparatus 10 and the imaging apparatus 20 are housed in the same housing, and may be configured as an integrated information processing apparatus. Further, at least part of the processing of each functional unit of the information processing apparatus 10 may be executed by the imaging apparatus 20. Such an information processing apparatus 10 is also included in an example of the “information processing apparatus” of the present disclosure.

### <Effects of Present Disclosure>

When other objects move in front of a person as seen from the imaging apparatus 20 and when the person moves in rear of other objects as seen from the imaging apparatus 20, at least a part of the body of the person may be hidden behind other objects. While at least a part of the body of the person is hidden behind other objects, the behavior of the person may not be detected.

As described above, according to the present disclosure, when the total length of time, during which the person is performing specific behavior in a specific period, is equal to or greater than a threshold, a warning is output. Thus, it is possible to appropriately output a warning based on the image.

The present invention is not limited to the above-described example embodiments, and can be modified as appropriate without departing from the scope and spirit of the invention.

Some or all of the above-described example embodiments may also be described as in the following Supplementary Notes, but are not limited to the following.

### (Supplementary Note 1)

An information processing apparatus including:
acquisition means for acquiring information detected based on an image captured by an imaging apparatus;
determination means for performing a first determination process of determining to output a warning when a type of an object detected at time of start and end of a first period is a person, and a second determination process of determining to output a warning when behavior of the person detected based on the image continues for a second period or longer; and
output means for outputting the warning based on a result determined by the determination means.

### (Supplementary Note 2)

In the information processing apparatus according to Supplementary Note 1, the determination means executes the first determination process when the behavior of the person detected based on the image is first behavior, and executes the second determination process when the behavior of the person detected based on the image is second behavior.

### (Supplementary Note 3)

In the information processing apparatus according to Supplementary Note 1 or 2, the determination means determines to output a warning when a total length of time, during which specific behavior of the person based on the image is detected in a specific period, is equal to or greater than a first threshold.

### (Supplementary Note 4)

In the information processing apparatus according to Supplementary Note 3, the determination means determines not to output the warning when a period, during which the specific behavior of the person based on the image is not continuously detected in the specific period, is equal to or greater than a second threshold.

### (Supplementary Note 5)

In the information processing apparatus according to Supplementary Note 4, the determination means determines, based on a predetermined condition, at least one of a length of the specific period, the first threshold, and the second threshold.

### (Supplementary Note 6)

In the information processing apparatus according to Supplementary Note 4 or 5, the determination means determines, based on at least one of a surrounding circumstance of the person determined based on the image and a type of an object in front of the person detected based on the image, at least one of a length of the specific period, the first threshold, and the second threshold.

### (Supplementary Note 7)

In the information processing apparatus according to any one of Supplementary Notes 4 to 6, the determination means determines, based on at least one of an attribute of the person determined based on the image, a time at which the image is captured, a place where the image is captured, and a type of the specific behavior, at least one of a length of the specific period, the first threshold, and the second threshold.

### (Supplementary Note 8)

In the information processing apparatus according to any one of Supplementary Notes 1 to 7, the information processing apparatus includes setting means for setting a determination method according to at least one of each region in the image captured by the imaging apparatus and a type of the behavior of the person, and
the determination means performs a determination process based on the determination method set by the setting means.

### (Supplementary Note 9)

An information processing method including:
acquiring information detected based on an image captured by an imaging apparatus;
determining to output a warning when a type of an object detected at time of start and end of a first period is a person, and determining to output a warning when behavior of the person detected based on the image continues for a second period or longer; and
outputting the warning based on the determination result.

### (Supplementary Note 10)

A non-transitory computer-readable medium storing a program that causes an information processing apparatus to execute:
a process of acquiring information detected based on an image captured by an imaging apparatus;
a first determination process of determining to output a warning when a type of an object detected at time of start and end of a first period is a person, and a second determination process of determining to output a warning when behavior of the person detected based on the image continues for a second period or longer; and
a process of outputting the warning based on a determination result.

### (Supplementary Note 11)

An information processing system including:
an imaging apparatus that captures an image and an information processing apparatus,
the information processing apparatus including:
acquisition means for acquiring information detected based on an image captured by the imaging apparatus;
determination means for performing a first determination process of determining to output a warning when a type of an object detected at time of start and end of a first period is a person, and a second determination process of determining to output a warning when behavior of the person detected based on the image continues for a second period or longer; and
output means for outputting the warning based on a result determined by the determination means.

### (Supplementary Note 12)

In the information processing system according to Supplementary Note 11, the determination means executes the first determination process when the behavior of the person detected based on the image is first behavior, and executes the second determination process when the behavior of the person detected based on the image is second behavior.

This application is based upon and claims the benefit of priority from Japanese Patent Application No. 2021-059305, filed on Mar. 31, 2021, the entire contents of which are incorporated herein by reference.

### REFERENCE SIGNS LIST

1 INFORMATION PROCESSING SYSTEM
10 INFORMATION PROCESSING APPARATUS
11 ACQUISITION UNIT
12 DETERMINATION UNIT
13 OUTPUT UNIT
20 IMAGING APPARATUS

What is claimed is:

1. An information processing apparatus comprising:
at least one memory storing instructions, and
at least one processor configured to execute the instructions to;
acquire information detected based on an image captured by an imaging apparatus;
perform a first determination process of determining to output a warning when a type of an object detected at time of start and end of a first period is a person, and a second determination process of determining to output a warning when behavior of the person detected based on the image continues for a second period or longer; and
output the warning based on a result of the determination.

2. The information processing apparatus according to claim 1, wherein the at least one processor executes the first determination process when the behavior of the person detected based on the image is first behavior, and executes the second determination process when the behavior of the person detected based on the image is second behavior.

3. The information processing apparatus according to claim 1, wherein the at least one processor determines to output a warning when a total length of time, during which specific behavior of the person based on the image is detected in a specific period, is equal to or greater than a first threshold.

4. The information processing apparatus according to claim 3, wherein the at least one processor determines not to output the warning when a period, during which the specific behavior of the person based on the image is not continuously detected in the specific period, is equal to or greater than a second threshold.

5. The information processing apparatus according to claim 4, wherein the at least one processor determines, based on a predetermined condition, at least one of a length of the specific period, the first threshold, and the second threshold.

6. The information processing apparatus according to claim 4, wherein the at least one processor determines, based on at least one of a surrounding circumstance of the person determined based on the image and a type of an object in front of the person detected based on the image, at least one of a length of the specific period, the first threshold, and the second threshold.

7. The information processing apparatus according to claim 4, wherein the at least one processor determines, based on at least one of an attribute of the person determined based on the image, a time at which the image is captured, a place where the image is captured, and a type of the specific behavior, at least one of a length of the specific period, the first threshold, and the second threshold.

8. The information processing apparatus according to claim 1, wherein
the at least one processor configured to execute the instructions to:
set a determination method according to at least one of each region in the image captured by the imaging apparatus and a type of the behavior of the person, and
the at least one processor performs a determination process based on the determination method set by the setting means.

9. An information processing method comprising:
acquiring information detected based on an image captured by an imaging apparatus;
determining to output a warning when a type of an object detected at time of start and end of a first period is a person, and determining to output a warning when behavior of the person detected based on the image continues for a second period or longer; and
outputting the warning based on the determination result.

10. A non-transitory computer-readable medium storing a program that causes an information processing apparatus to execute:
a process of acquiring information detected based on an image captured by an imaging apparatus;
a first determination process of determining to output a warning when a type of an object detected at time of start and end of a first period is a person, and a second determination process of determining to output a warning when behavior of the person detected based on the image continues for a second period or longer; and
a process of outputting the warning based on a determination result.

11. (canceled)

12. (canceled)

13. The information processing method according to claim 9, wherein the determining executes the first determination process when the behavior of the person detected based on the image is first behavior, and executes the second determination process when the behavior of the person detected based on the image is second behavior.

14. The information processing method according to claim 9, wherein the determining determines to output a warning when a total length of time, during which specific behavior of the person based on the image is detected in a specific period, is equal to or greater than a first threshold.

15. The information processing method according to claim 14, wherein the determining determines not to output the warning when a period, during which the specific behavior of the person based on the image is not continuously detected in the specific period, is equal to or greater than a second threshold.

16. The information processing method according to claim 15, wherein the determining determines, based on a predetermined condition, at least one of a length of the specific period, the first threshold, and the second threshold.

17. The information processing method according to claim 15, wherein the determining determines, based on at least one of a surrounding circumstance of the person determined based on the image and a type of an object in front of the person detected based on the image, at least one of a length of the specific period, the first threshold, and the second threshold.

18. The non-transitory computer-readable medium storing a program according to claim 10, wherein the first determination process is executed when the behavior of the person detected based on the image is first behavior, and the second determination process is executed when the behavior of the person detected based on the image is second behavior.

19. The non-transitory computer-readable medium storing a program according to claim 10, wherein the determination process determines to output a warning when a total length of time, during which specific behavior of the person based on the image is detected in a specific period, is equal to or greater than a first threshold.

20. The non-transitory computer-readable medium storing a program according to claim 19, wherein the determination process determines not to output the warning when a period, during which the specific behavior of the person based on the image is not continuously detected in the specific period, is equal to or greater than a second threshold.

21. The non-transitory computer-readable medium storing a program according to claim 20, wherein the determination process determines, based on a predetermined condition, at least one of a length of the specific period, the first threshold, and the second threshold.

22. The non-transitory computer-readable medium storing a program according to claim 20, wherein the determination process determines, based on at least one of a surrounding circumstance of the person determined based on the image and a type of an object in front of the person detected based on the image, at least one of a length of the specific period, the first threshold, and the second threshold.
